(19) United States
(12) Patent Application Publication
(10) Pub. No.: US 2009/0287553 A1
(43) Pub. Date: Nov. 19, 2009

(54) System and Method for Website Monetization

(76) Inventor: Michele Colucci, Woodside, CA (US)

Correspondence Address: SHEPPARD, MULLIN, RICHTER & HAMPTON LLP, 990 Marsh Road, Menlo Park, CA, 94025, US

(21) Appl. No.: 12/467,220

(22) Filed: May 15, 2009

Related U.S. Application Data
(60) Provisional application No. 61/053,624, filed on May 15, 2008.

(51) Int. Cl. G06Q 30/00; G06Q 50/00

(52) U.S. Cl. 705/14.7; 705/14.69; 705/14.72

(57) ABSTRACT

The present invention provides a website monetization system on a central computer, the website monetization system comprising a web page creation tool, a website hosting tool, an advertising tool, a content provision tool, a monetization tool, and a franchisee payment tool. The central server comprises a central website on a particular interest; a website creation tool operative to provide web page development tools to a franchise administrator system for generating a franchise website on the particular interest as it pertains to a target region, the web page development tools including an advertising tool for adding an advertisement of an advertiser associated with the target region into the franchise website, and a franchisee payment tool for providing a franchise payment to a party associated with the central website.

### PRIORITY CLAIM

This application claims the benefit of and incorporates by reference U.S. Provisional Application No. 61/053,624, filed on May 15, 2008 and entitled “System and Method for Blog Monetization.”

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND

1. Field of the Invention

The present invention pertains generally to the field of website monetization. More particularly, the invention pertains to systems and methods for monetization of local/regional websites, such as websites focused on particular schools, Little League® teams, political groups, and other local/regional interests.

2. Technical Background

With the rise of the Internet, there has been a proliferation of websites focused on a variety of interests. Websites administrators, however, have often found it hard to monetize their work. National advertisers are often unwilling to advertise on websites focused on local/regional interests, and local advertisers are frequently reluctant to advertise on websites that are not based upon a proven trademark and/or formula of doing business.

It should be appreciated from the foregoing description that there is a need for an improved system and method for website monetization that addresses the difficulties in monetizing websites, especially those focused on local/regional interests. The present invention satisfies this need and provides further related advantages.

### SUMMARY OF THE INVENTION

In accordance with an embodiment, the present invention provides a website monetization system comprising a web page creation tool, a website hosting tool, an advertising tool, a content provision tool, a monetization tool, and a franchisee payment tool.

The web page creation tool provides one or more preformatted web page templates to a franchise administrator system located in a target region. The web page creation tool may also provide one or more modules to the franchise administrator system, such as an advertising module, a content module, a fundraiser module, a buy/sell/donate/trade module, a listings module, a ratings module, a calendar module, a blog module, and a discussion forum module, a design module, a language module, an information aggregation module, a features module, etc.

The advertising tool incorporates one or more advertisements obtained from one or more advertisers located in the target region into the one or more preformatted web page templates to create one or more customized web pages.

The website hosting tool provides the one or more customized web pages to a server system connected to a wide-area network.

The content provision tool allows a franchise administrator at a franchise administrator system to customize or change a syndicated content option selected through the web page creation tool.

The monetization tool allows a franchise administrator at a franchise administrator system to track and manage revenues generated by hosted web pages.

The franchisee payment tool allows a franchise administrator at a franchise administrator system to enter advertising revenues received from region advertisers and to calculate the share of the advertising revenues belonging to the franchise administrator.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a block diagram of a network system for website monetization, in accordance with an embodiment of the present invention.

FIG. 2 is a block diagram of a central server for a website monetization system, in accordance with an embodiment of the present invention.

FIG. 3 is a block diagram of a website monetization system, in accordance with an embodiment of the present invention.

FIG. 4 is a block diagram of a central database for a website monetization system, in accordance with an embodiment of the present invention.

FIG. 5 is a flowchart of a web page creation method, in accordance with an embodiment of the present invention.

FIG. 6 is a flowchart of a website hosting method, in accordance with an embodiment of the present invention.

FIG. 7 is a flowchart of a website display method, in accordance with an embodiment of the present invention.

FIG. 8 is a flowchart of a website monetization method, in accordance with an embodiment of the present invention.

FIG. 9 is a mockup of a preformatted web page configured for an elementary school parent, in accordance with an embodiment of the present invention.

### DETAILED DESCRIPTION

The following description is provided to enable any person skilled in the art to make and use the invention. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features, and teachings disclosed herein.

Various system elements, components, tools, etc. are described with reference to a school embodiment. One skilled in the art will recognize that the system and method may be used for other local/regional purposes, such as local/regional sports teams, local/regional political groups, and other local/regional interests.

### Network System for Website Monetization

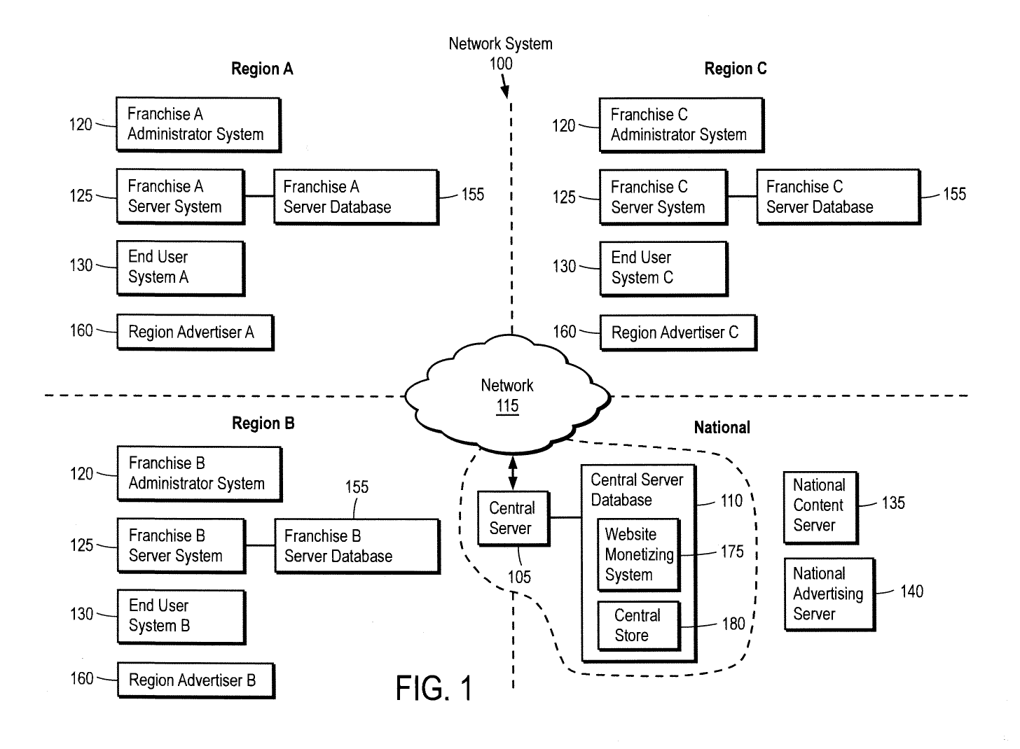

Referring now to the drawings, and particularly to FIG. 1, there is shown a block diagram of a network system 100 for website monetization, in accordance with an embodiment of the present invention.

The network system 100 comprises a central server 105 coupled to a central server database 110 and a wide-area network 115, such as the Internet. The network 100 further includes franchise administrator systems 120, such as the Franchise A administrator system (possibly located in region A), Franchise B administrator system (possibly located in region B), and Franchise C administrator system (possibly located in region C). The network 100 also includes franchise server systems 125 such as the Franchise A server system (possibly located in region A), Franchise B server system (possibly located in region B), and Franchise C server system (possibly located in region C). Each franchise server system 125 is coupled to a franchise server database 155. That is, Franchise A server system 125 is coupled to Franchise A server database 155. Franchise B server system 125 is coupled to Franchise B server database 155. Franchise C server system 125 is coupled to Franchise C server database 155.

The network 100 also includes region advertisers 160 such as region advertiser A (possibly located in region A), region advertiser B (possibly located in region B), and region advertiser C (possibly located in region A). It will be appreciated that the terms local and regional are being used interchangeably. The network 100 also may include national content servers 135 and national advertising servers 140 (possibly located outside of any of region A, B or C). The network 100 also end user systems 130, including end user system A (possibly located in region A), end user system B (possibly located in region B), and end user system C (possibly located in region A).

In one embodiment, the central server 105 includes hardware, software, and/or firmware generally operative to receive and transmit information to one or more systems on the network 115. The central server 105 includes a website monetization system 175 capable to provide the website development tools to each of the franchise administrator systems 120 and/or franchise server systems 125 to enable website development and hosting by the franchise administrators. It will be appreciated that the franchise administrator system 120 and franchise server system 125 are essentially interchangeable. Development, management and hosting can be done on either or both of these systems 120 or 125. Accordingly, a “franchise system” broadly refers to either the franchise administrator system 120 or franchise server system 125.

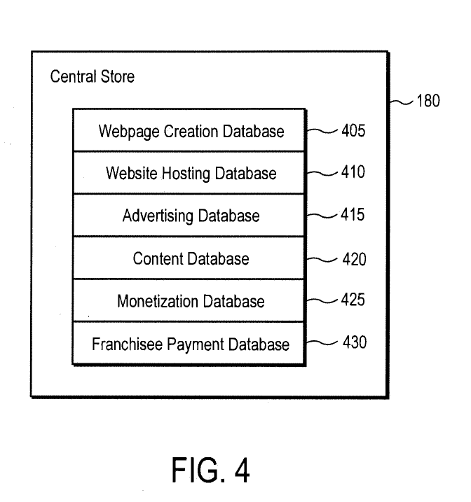

The central server 105 also includes a central store 180 capable to store web pages, advertisements, content, and payment information. FIG. 4 illustrates an example central store 180, which includes web page creation database 405, website hosting database 410, advertising database 415, content database 420, monetization database 425, and franchisee payment database 430.

In one embodiment, the central server 105 may host a central website dedicated to a particular interest, e.g., private schools. In another embodiment, the central server 105 is a portal to a variety of interests, e.g., private schools, public schools, political groups, sport leagues, social clubs, etc. It will be appreciated that a franchise administrator operating a franchise administrator system 120 may wish to develop and host a franchise website on the franchise server system 125. Being either a resident of region A or concerned in some manner with an interest of region A (e.g., a kid of the franchise administrator goes to a particular school in region A, the franchise administrator went to a school in region A, the franchise administrator likes a particular social club in region A, the franchise administrator is involved in a political group affiliated with region A, or other reason), the franchise administrator may wish to generate a franchise website about the local interest. The franchise administrator can sign up with the central server 105 to operate a franchise site about the local interest, e.g., the local public high school. The central server 105 uses a website monetizing system 175 stored on the central server database 110 to support the franchise site. The monetizing system 175 provides the tools needed for the franchise administrator to develop the franchise website and establishes a link to the franchise website from the central website. In exchange, the central administrator of the central server 105 or some other party gets for a portion of certain proceeds from the franchise site, e.g., advertising revenue.

### General Computer

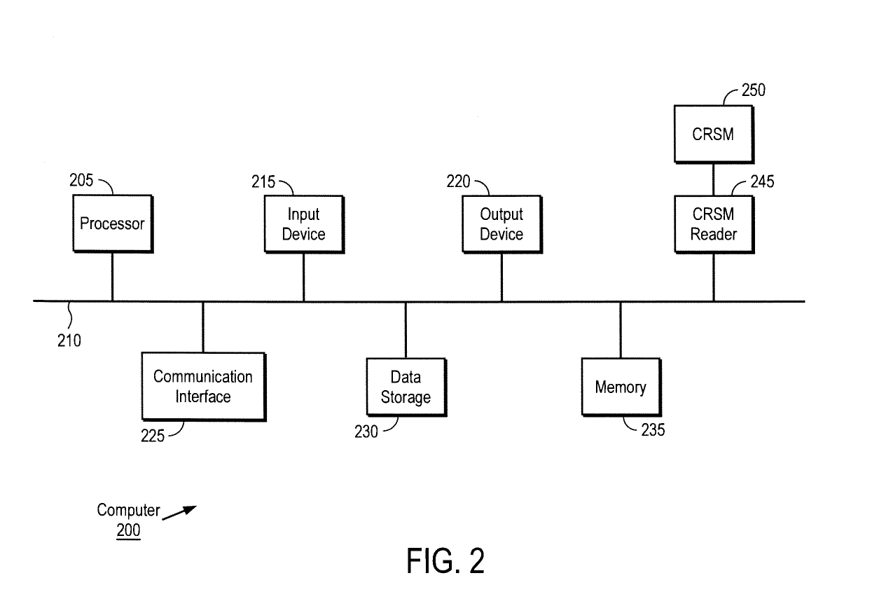

With reference to FIG. 2, there is shown a block diagram of a computer system 200. Each of the franchise administrator system 120, franchise server system 125, end user system 130, central server 105, national content server 135 and region advertiser B may be an instance of computer system 200. The computer system 200 includes a processor 205, such as an Intel Pentium® microprocessor or a Motorola Power PC® microprocessor, coupled to a communications channel 210. The computer system 200 further includes an input device 215 (such as a keyboard or mouse), an output device 220 (such as a liquid crystal display or a cathode ray tube display), a communication interface 225, a data storage device 230 (such as a magnetic or optical disk), and memory 235 (such as random access memory (RAM)), each coupled to the communications channel 210. The communication interface 225 may be coupled to the network 115. One skilled in the art will recognize that, although the data storage device 230 and memory 235 are shown as different units, the data storage device 230 and memory 235 may be parts of the same unit, distributed units, virtual memory, etc. Further, it will be appreciated that the term “memory” herein is intended to cover all data storage media, whether permanent or temporary.

The data storage device and/or the memory may also store an operating system (not shown), such as Microsoft Windows Vista, Linux, the IBM OS/2 operating system, the MAC OS, or the UNIX operating system. It will be appreciated that embodiments of the present invention may also be implemented on platforms and operating systems other than those mentioned. An embodiment of the present invention may be written using JAVA, C, C++ language, and/or other programming languages, possibly using object oriented programming methodology. The present invention may be built on Ruby on Rails or using Ajax.

One skilled in the art will recognize that the computer system 200 may also include additional components, such as network connections, additional memory, additional processors, local area networks (LANs), and input/output lines for transferring information across a hardware channel, the Internet or an intranet. One skilled in the art will also recognize that the programs and data may be received by and stored in the computer system 200 in alternative ways. For example, a computer-readable storage medium (CRSM) reader 245, such as a magnetic disk drive, hard disk drive, magneto-optical reader, or CPU, may be coupled to the communications channel 210 for reading a computer-readable storage medium (CRSM) 250, such as a magnetic disk, a hard disk, a magneto-optical disk, or RAM. Accordingly, the central server may receive programs and/or data via the CRSM reader.

### Website Monetization System

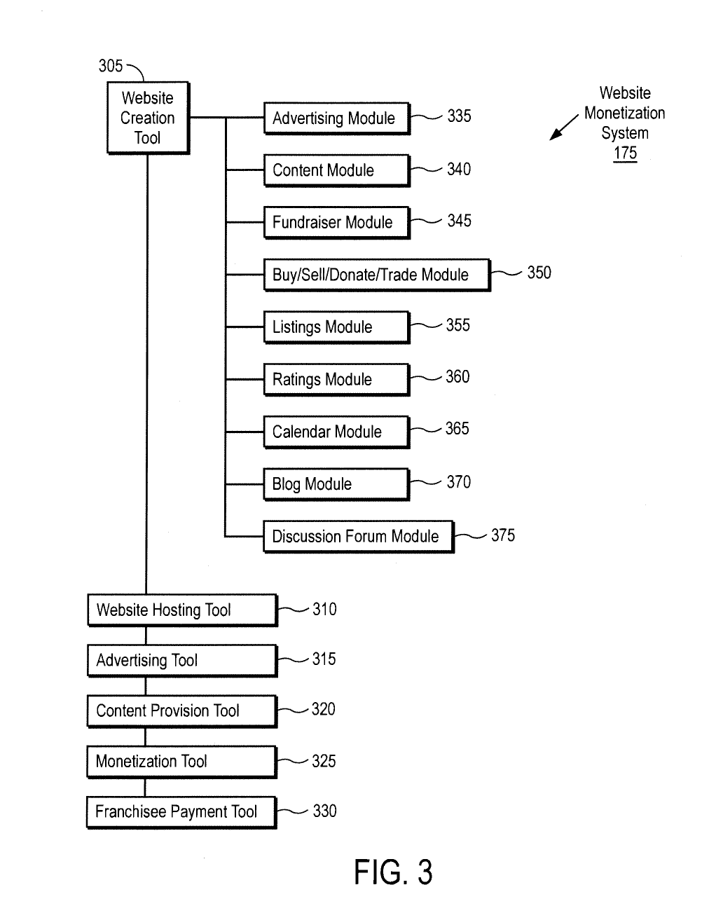

With reference to FIG. 3, there is shown a block diagram of a website monetization system 175, in accordance with an embodiment of the present invention. The website monetization system 175 includes a website creation tool 305, a website hosting tool 310, an advertising tool 315, a content provision tool 320, a monetization tool 325, and a franchisee payment tool 330.

In one embodiment, the tools of the website monetization system 175 are accessed by franchise administrators through the central server 105. A franchise administrator may download the tools to a franchise administrator system 120 or may work with the tools on the central server 105. The central server 105 may host the central website, e.g., weblogs (“blogs”), on topics of interest to school parents (such as school quality, tutoring, extracurricular classes, foreign language instruction, testing help and information on the Independent School Entrance Exam (ISEE) and other tests, essay writing, psychological counseling, college counseling, career counseling, private school coaches, uniforms, books, fundraisers, and school supplies). Using the tools, the franchise administrator may generate a franchise site of a format similar to the central website.

The website creation tool 305 includes hardware, software, and/or firmware operative to allow a franchise administrator at a franchise administrator system 120 to create a website having one or more web pages focused on a local interest. Draft and final versions of the web page(s) may be stored in a database coupled to the franchise administrator system or in the web page creation database 405 (see FIG. 4).

In one embodiment, the website creation tool 305 includes an advertising module 335, a content module 340, a fundraiser module 345, a buy/sell/donate/trade module 350, a listings module 355, a ratings module 360, a calendar module 365, a blog module 370, and a discussion forum module 375. The franchise administrator may incorporate one or more of these modules into one or more preformatted web page templates offered by the website creation tool 305 to create the franchise website.

The advertising module 335 is configured to display advertisements. In one embodiment, the franchise administrator may obtain the advertisement from a region advertiser 160, such as a local pizza place or market. Additionally or alternatively, the franchise administrator may choose from a list of preprogrammed advertising options provided by the central server 105 and/or a national advertising server 140. The preprogrammed advertising options may include national advertising negotiated at a national level for use at the local website level.

The content module 340 is configured to present (display, perform, playback, etc.) substantive content, such as blog entries, news articles, audio, and video. The franchise administrator may generate the substantive content himself or herself. Additionally or alternatively, the franchise administrator may choose from a list of syndicated content options provided by the central server 105 and/or a national content server 135. The substantive content may be provided to the franchise administrator through a web feed format such as RSS or Atom.

The fundraiser module 345 is configured to allow the franchise administrator to facilitate or conduct fundraisers through the franchise website (also referred to herein as the “local website”) created by the website creation tool 305.

The buy/sell/donate/trade module 350 is configured to allow the franchise administrator to facilitate or conduct sales, donations, and/or trades of uniforms, books, supplies, and other items through the local website.

The listings module 355 is configured to allow the franchise administrator to solicit and publish address, telephone, and other listings through the local website. Access to the listings may be controlled by the franchise administrator and restricted to certain individuals. This may be accomplished by setting up and distributing user names and passwords through the website monetization system 175.

The ratings module 360 is configured to allow the franchise administrator to solicit and publish ratings for tutors, psychiatric professionals, test preparation courses, and other individuals and businesses through the local website.

The calendar module 365 is configured to allow the franchise administrator to solicit and publish entries for a calendar of events through the local website. The calendar module 365 may be configured to send automatic reminders via e-mail, text message, and other means known in the art.

The blog module 370 is configured to allow the franchise administrator to solicit and publish blog entries through the local website. The discussion forum module 375 is configured to allow the franchise administrator to host an online discussion forum through the local website about a topic of interest.

After incorporating one or more modules into a preformatted web page template, the franchise administrator may add text, designs, logos, and other web page elements to customize the look and feel of each page of the franchise website.

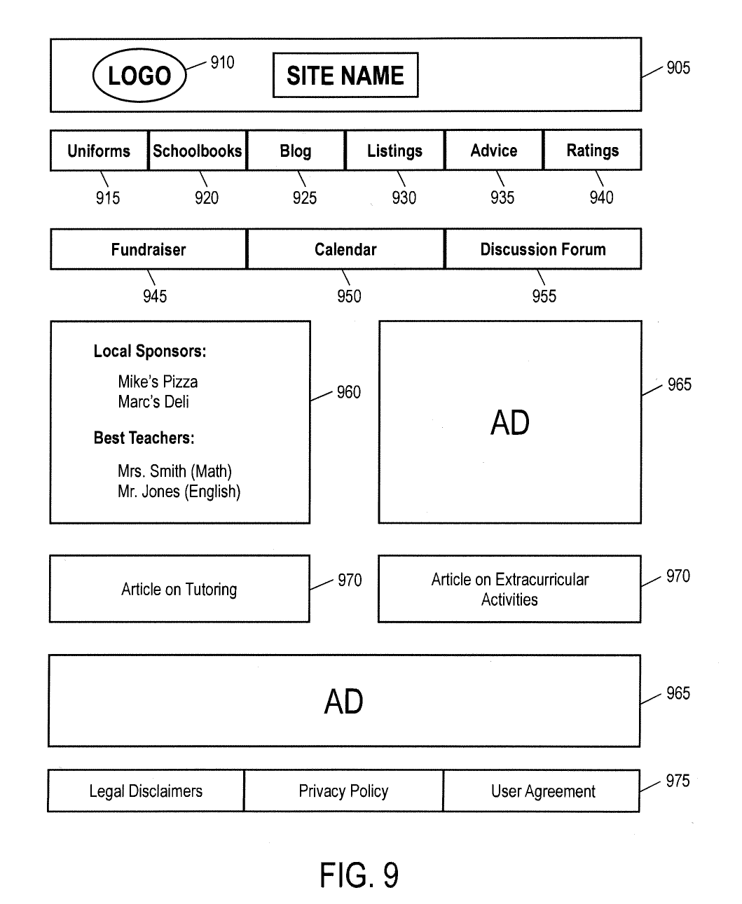

FIG. 9 is a mockup of a preformatted web page 900 configured for an elementary school parent, in accordance with an embodiment of the present invention. Other embodiments of the preformatted web page may include greater or fewer numbers of modules, and the franchise administrator may add or remove modules from the web page during the customization process. The preformatted web page template may include a header 905 bearing the trademark logo 910 of the central site with space for an franchise site name. The logo may include a hard-coded link to the central site.

The preformatted web page 900 includes a buy/sell/donate/trade module 915 for school uniforms. Selecting this module opens a separate preformatted web page template on which the franchise administrator may list descriptions, sizes, conditions (e.g., excellent, good, average, poor), prices, and other information for uniforms that end users want to sell or trade. The preformatted web page 900 also includes a buy/sell/donate/trade module 920 for schoolbooks. Selecting this module opens a separate preformatted web page template on which the franchise administrator may list descriptions, conditions, prices, and other information for schoolbooks that end users want to sell or trade.

The preformatted web page 900 additionally includes a school blog module 925, through which the franchise administrator may publish blog entries written by the franchise administrator or submitted by end users. In one embodiment, the website monetization system 175 is configured to transfer the blog entries to the central server 105 so that the entries may be additionally published on the central site.

The preformatted web page 900 further includes a listings module 930 for tutors, counselors, and test preparation services. Selecting this module opens a separate preformatted web page template on which the franchise administrator may list the names and contact information of tutors, counselors, and test preparation services.

The preformatted web page 900 further includes a content module 935 for school advice, such as advice on teacher gifts, tuition, and donations.

Also on the preformatted web page 900 is a ratings module 940 for teachers. Selecting this module opens a separate preformatted web page template on which the franchise administrator may provide the names and grade levels of teachers at the school, along with an anonymous (1-10) rating and comments. End users may submit their own ratings and comments through this module.

The preformatted web page 900 further includes a fundraiser module 945 configured to allow the franchise administrator to conduct a school fundraiser.

Also on the preformatted web page 900 is a calendar module 950 for school events, so parents can stay informed about what is happening at the school and what is needed for field trips, classroom parties, holidays, etc.

The preformatted web page 900 further includes a discussion forum module 955, through which the franchise administrator may host an online discussion forum about a topic of interest.

Also on the preformatted web page 900 is a content module 960 in which the franchise administrator may list the names of local sponsors, along with the best-rated teachers at the school.

Positioned around the other modules on the preformatted web page 900 are various advertising modules 965 and syndicated content modules 970. The advertising modules are configured as preformatted rectangles for advertisements provided by a region advertiser 160 or through a preprogrammed advertising option. The syndicated content modules are configured as preformatted rectangles for syndicated articles on education provided by the central server 105 and/or a national content server 135.

Further, the preformatted web page 900 includes links 975 to legal disclaimers, privacy policies, user agreements, and other legal documents.

With reference again to FIG. 3, the website hosting tool 310 includes hardware, software, and/or firmware operative to allow a franchise administrator at a franchise administrator system 120 to publish a franchise website created using the website creation tool 305 to the World Wide Web through the franchise administrator system 120, through a separate franchise server system 125, or through the central server 105.

The advertising tool 315 includes hardware, software, and/or firmware operative to allow a franchise administrator at a franchise administrator system 120 to incorporate advertisements obtained from region advertisers 160 into advertising modules 335 included in a web page created through the website creation tool 305. The advertising tool may also allow the franchise administrator to customize or change a preprogrammed advertising option selected through the website creation tool 305. Data pertaining to the various preprogrammed advertising options and the advertisements themselves may be stored in a database coupled to the franchise administrator system 120, in a franchise server database 155, or in an advertising database 415 (see FIG. 4).

In one embodiment, the advertising tool 315 presents a button reading “add advertiser.” The franchise administrator adds each local and/or national advertisement. It will be appreciated that there the advertising module 335 may require an approval process before allowing advertisements to be posted to a franchise website.

The content provision tool 320 includes hardware, software, and/or firmware operative to allow a franchise administrator at a franchise administrator system 120 to incorporate self-generated content into content modules 340 included in a web page created through the website creation tool 305. The content provision tool 320 may also allow the franchise administrator to customize or change a syndicated content option selected through the website creation tool 305. Data pertaining to the various syndicated content options and the substantive content itself may be stored in a database coupled to the franchise administrator system, in a franchise server database 155, or in a content database 420 (see FIG. 4).

After the franchise website has been launched, the end user system 130 may visit the franchise website and view the advertisements of region advertisers 160. Because it is likely that the end user of end user system 130 is a resident of or visits the region, the advertisements may be better targeted. Thus, region advertisers 160 may be more willing to pay for advertisements on the franchise website.

The monetization tool 325 includes hardware, software, and/or firmware operative to allow a franchise administrator at a franchise administrator system 120 to track and manage revenues generated by a website created using the website creation tool 305. The monetization tool 325 would allow local advertising contracts to be downloaded from the central server 105 and then signed ones uploaded. The monetization tool 325 tracks and manages measuring statistics for advertisements included in the franchise website through one or more methods known in the art, such as pay per impression, pay per click, pay per play, and pay per action. The monetization tool 325 can then calculate and display the franchise administrator's share of the advertising revenues vis-à-vis the share belonging to the administrator of the central website (per agreement between the franchise administrator and the central site administrator). For instances in which the franchise administrator has chosen a preprogrammed advertising option provided by the central server 105 and/or a national advertising server 140, the monetization tool can provide options for how the franchise administrator would like to receive his or her share (e.g., by check, electronic funds transfer, etc.). Data pertaining to the advertising revenues and measuring statistics may be stored in a database coupled to the franchise administrator system, in a franchise server database 155, or in a monetization database 425 (see FIG. 4).

The franchisee payment tool 330 includes hardware, software, and/or firmware operative to allow a franchise administrator at a franchise administrator system 120 to enter advertising revenues received from region advertisers 160 into the website monetization system 175 and to calculate the share of the local advertising revenues to be sent to the central site administrator of the central site, per agreement between the franchise administrator and the central site administrator. The monetization tool 330 can then provide options for how the franchise administrator would like to pay his or her share to the central site administrator (e.g., by credit card, electronic funds transfer, etc.). Data pertaining to the advertising revenues and the franchise-central site agreement may be stored in a database coupled to the franchise administrator system, in a franchise server database 155, or in a franchisee payment database 430 (see FIG. 4).

Although not shown, the website monetization system 175 may include other tools and/or modules, such as a design module (to enable modifying format, color, skins, etc.), a language module (to enable language translation), an information aggregation module (to enable grouping content in different ways), a features module (to enable modifying the features on the web page), etc.

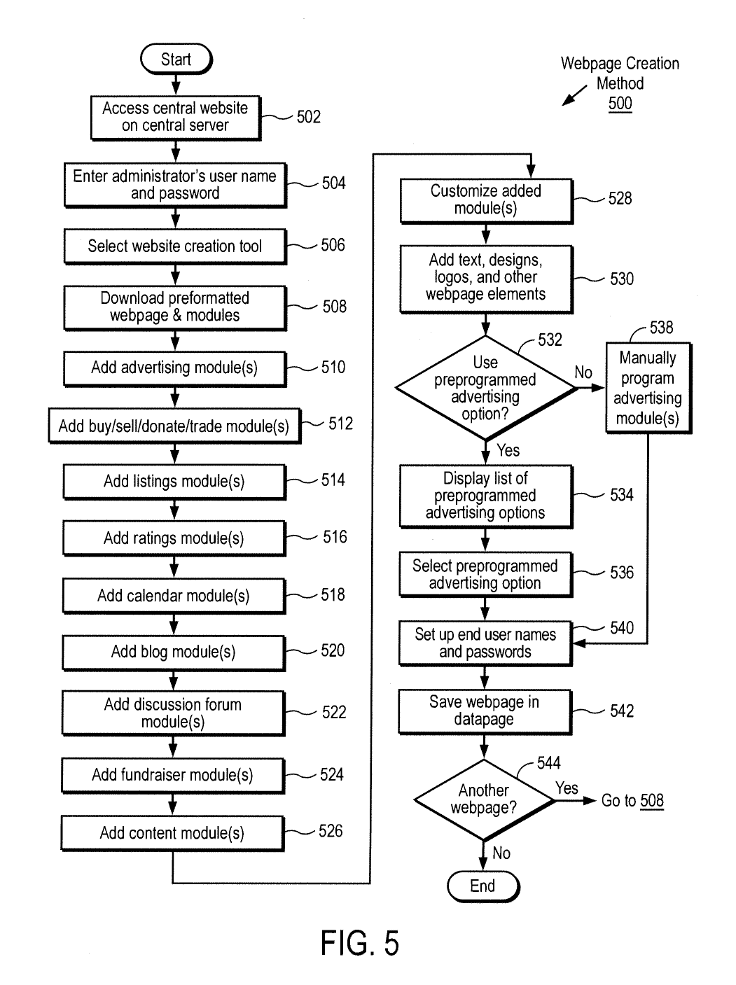

With reference to FIG. 5, there is shown a flowchart of a web page creation method 500, in accordance with an embodiment of the present invention. The web page creation method 500 begins in step 502 with the franchise administrator at a franchise administrator system 120 accessing the central site on the central server 105 through a software application, such as a web browser. In step 504, the franchise administrator enters his or her user name and password into designated fields on the central site. In step 506, the franchise administrator selects an icon representing the website creation tool 305 using an input device 145. In step 508, the central server 105 transmits a preformatted web page template and the modules discussed above to the franchise administrator system 120.

In steps 510, 512, 514, 516, 518, 520, 522, 524 and 526, the franchise administrator may choose to add one or more advertising modules 335, content modules 340, fundraiser modules 345, buy/sell/donate/trade modules 350, listings modules 355, ratings modules 360, calendar modules 365, blog modules 370, and discussion forum modules 375 to the preformatted web page template. In step 528, the franchise administrator may customize the added module(s), for example, by choosing a syndicated content option for a content module 340. In step 530, the franchise administrator may add text, designs, logos, and other web page elements. These steps may be performed on the franchise administrator system 120 (e.g., offline) or on the central server 105 (e.g., online).

In step 532, the franchise administrator determines whether to use a preprogrammed advertising option. If the franchise administrator chooses to use a preprogrammed advertising option, then the web page creation method 500 proceeds to step 534. In step 534, the franchise administrator system 120 displays a list of preprogrammed advertising options on the output device 150. In step 536, the franchise administrator selects a preprogrammed advertising option from the list using an input device 145. The franchise administrator system or central server 105 then configures one or more advertising modules 335 according to the selected preprogrammed advertising option.

If the franchise administrator chooses not to use a preprogrammed advertising option, then the web page creation method 500 proceeds to step 538. In step 538, the franchise administrator uses the advertising tool 315 to manually program one or more advertising modules 335 according to advertisements separately obtained from region advertisers 160. This step may be performed offline on the franchise administrator system 120 or online on the central server 105.

In step 540, the franchise administrator may provide identifying information, e.g., the e-mail addresses, of end users whom the franchise administrator wants to have access to the finished website, or to selected modules thereof. The franchise administrator system 120 or central server 105 then sets up end user names and passwords for the designated end users, and e-mails the end user names and passwords to the designated end users. Alternatively, the franchise website may be open to everyone.

In step 542, the finished web page is saved in a database coupled to the franchise administrator system 120, in the franchiser server database 155 or in the web page creation database 405. In step 544, the franchise administrator is asked whether he or she would like to create another web page. If the franchise administrator chooses to create another web page, then processing returns to step 508. If not, then the web page creation method 500 ends.

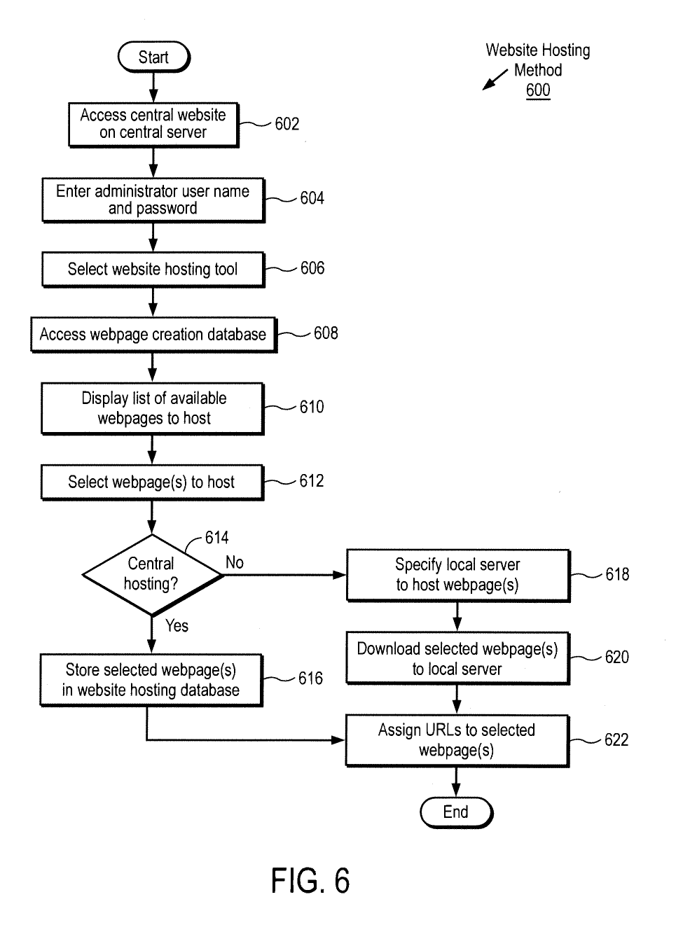

With reference to FIG. 6, there is shown a flowchart of a website hosting method 600, in accordance with an embodiment of the present invention, to be used when finished web pages have been stored in the web page creation database 405. The website hosting method 600 begins in step 602 with the franchise administrator at a franchise administrator system 120 accessing the central site on the central server 105 through a software application, such as a web browser. In step 604, the franchise administrator enters his or her user name and password into designated fields on the central site. In step 606, the franchise administrator selects an icon representing the website hosting tool 305 using an input device 145.

In step 608, the central server 105 accesses the web page creation database 405 and retrieves a list of web pages created by the website creation tool 305 that are available to host. In step 610, the central server transmits a list of web pages to the franchise administrator system 120, for display on an output device 150. In step 612, the franchise administrator selects one or more web pages from the list using an input device 145. In another embodiment, the franchise administrator informs the web page creation database 405 of the web page he or she wishes to host.

In step 614, the central server 105 transmits a query to the franchise administrator system 120 for display on an output device 150, asking whether the franchise administrator would like to host the selected web page(s) centrally on the central server 105. If the franchise administrator chooses to host the selected web page(s) centrally on the central server 105, then the website hosting method 600 proceeds to step 616. In step 616, the central server 105 stores the selected web pages in the website hosting database 410.

If the franchise administrator chooses not to host the selected web page(s) centrally on the central server 105, then the website hosting method 600 proceeds to step 618. In step 618, the franchise administrator specifies the franchise server system 125 to host the selected web page(s). In step 620, the central server 105 downloads the selected web page(s) to the specified franchise server system 125, either directly or indirectly through one or more intermediary systems. In one embodiment, a franchise administrator system 120 may serve as the franchise server system 125.

In step 622, one or more Uniform Resource Locators (URLs) are assigned to the selected web page(s) to allow the selected web pages to be accessed by end user systems 130 via the network 115. The website hosting method 600 then ends.

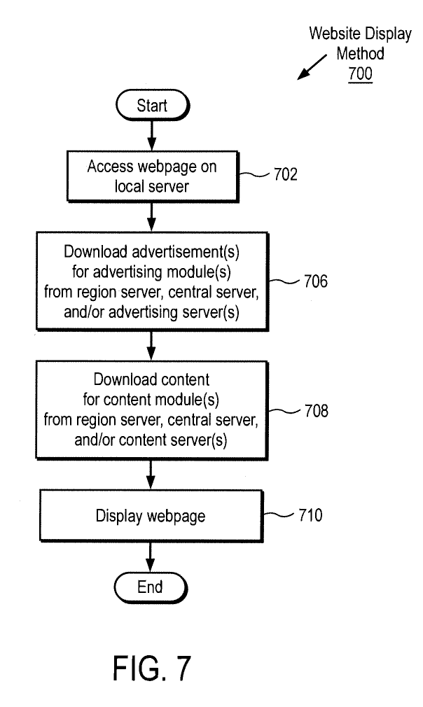

With reference to FIG. 7, there is shown a website display method 700, in accordance with an embodiment of the present invention. The website display method begins in step 702 with an end user at an end user system 130 attempting to access a web page residing on a franchise server system 125. In step 706, the franchise server system 125 triggers the end user system 130 to download one or more advertisements for one or more advertising modules 335 from the franchise server system 125, central server 105 and/or one or more national advertising servers 140. In step 708, the franchise server system 125 triggers the end user system 130 to download one or more items of syndicated content for one or more content modules 340 from the franchise server system, central server 105 and/or one or more national content servers 135. In step 710, the end user system displays the web page on an output device 220 of the end user device 130. The website display method then ends.

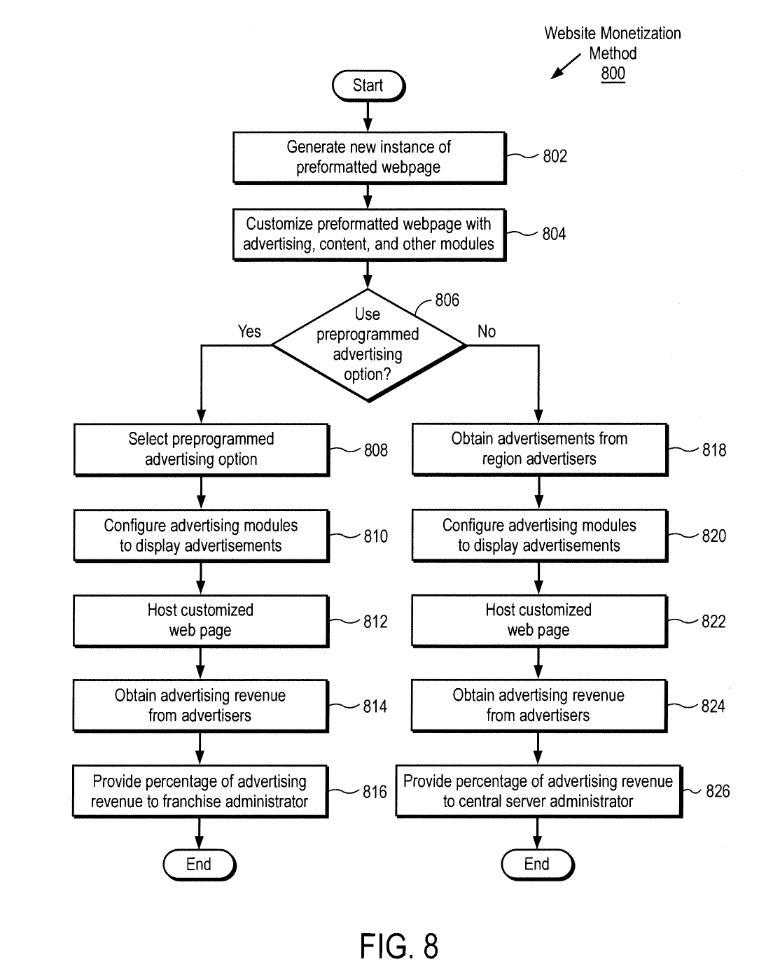

With reference to FIG. 8, there is shown a website monetization method 800, in accordance with an embodiment of the present invention. The website monetization method 800 begins in step 802 with a franchise administrator at a franchise administrator system 120 generating a new instance of a preformatted web page template. In step 804, the franchise administrator customizes the preformatted web page template with advertising, content, and other modules to create a customized web page.

In step 806, the franchise administrator chooses whether to use a preprogrammed advertising option offered by the administrator of the central server 105. If the franchise administrator chooses to use a preprogrammed advertising option, then the website monetization method 800 proceeds to step 808. In step 808, the franchise administrator selects a preprogrammed advertising option. In step 810, the franchise administrator system 120 or central server 105 configures one or more advertising modules 335 on the customized web page to display advertisements according to the selected preprogrammed advertising option. In step 812, the franchise administrator hosts the customized web page on the central server 105, on a franchise server system 125, or on the franchise administrator system 120. In step 814, the administrator of the central server 105 obtains advertising revenue from the advertisers whose advertisements are displayed on the customized web page. In step 816, the administrator of the central server provides a percentage of the advertising revenue to the franchise administrator. The website monetization method 800 then ends.

If the franchise administrator chooses not to use a preprogrammed advertising option, then the website monetization method 800 proceeds to step 818. In step 818, the franchise administrator obtains local advertisements from region advertisers 160. In step 820, the franchise administrator system 120 or central server 105 configures one or more advertising modules 335 on the customized web page to display the local advertisements. In step 822, the franchise administrator hosts the customized web page on the central server, on a franchise server system 125, or on the franchise administrator system itself. In step 824, the franchise administrator obtains local advertising revenue from the region advertisers 160 whose local advertisements are displayed on the customized web page. In step 826, the franchise administrator provides a percentage of the local advertising revenue to the administrator of the central server. The website monetization method 800 then ends.

It will be appreciated that, in one embodiment, a national website (like the Huffington Post or other national blog/group) may have difficulty finding national advertisers because the majority of potential advertisers have local businesses, not national businesses. And, local advertisers wish to pay for advertisements targeting only local customers. By licensing local focused web pages on a national website (i.e., baseball.com/Poughkeepsie) to local licensees/bloggers in exchange for an ad/revenue share of local advertisements, a national site can have both local and national advertisers. That way, local licensees can incorporate local or national advertisements.

It will be appreciated that a local licensee may be given editorial control over the portions of the national website that are published on the local focused web pages. For instance, The Huffington Post has many writers. A local licensee managing the LA-focused portion of the national website may be given control to feature certain LA-relevant content, to modify the colors or formats based on LA preferences, or to re-group or re-order the content (e.g., under a category depending on where the sub-local interests lie). Further, when a local blogger has gained enough followers, the national website may invite the local blogger to go national.

The foregoing description of the preferred embodiments of the present invention is by way of example only, and other variations and modifications of the above-described embodiments and methods are possible in light of the foregoing teaching. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A central server system comprising:
a central website server on a particular interest;
a website creation tool operative to provide web page development tools to a franchise system for generating a franchise website on the particular interest as it pertains to a target region, the web page development tools including
an advertising tool for adding an advertisement of an advertiser associated with the target region into the franchise website; and
a franchisee payment tool for providing a franchise payment to a party associated with the central website.

2. The central server of claim 1, wherein the particular interest includes private schools.

3. The central server of claim 1, wherein the franchise payment includes a percentage of the advertising revenue.

4. A method comprising:
hosting a central website on a particular interest;
providing web page development tools to a franchise system to generate a franchise website on the particular interest as it pertains to a target region;
using the web development tools to generate the franchise website associated with a target region;
adding an advertisement of an advertiser associated with the target region into the franchise website; and
providing a franchise payment to a party associated with the central website.

5. The method of claim 4, wherein the particular interest includes private schools.

6. The method of claim 4, wherein the franchise payment includes a percentage of the advertising revenue.

7. A system comprising:
means for hosting a central website on a particular interest;
means for providing web page development tools to a franchise system to generate a franchise website on the particular interest as it pertains to a target region;
means for using the web development tools to generate the franchise website associated with a target region;
means for adding an advertisement of an advertiser associated with the target region into the franchise website; and
means for providing a franchise payment to a party associated with the central website.
